(19) United States
(12) Patent Application Publication
(10) Pub. No.: US 2017/0263394 A1
(43) Pub. Date: Sep. 14, 2017

(54) ELECTRIC SHOCK PROTECTION STRUCTURE AND METHOD, AND ELECTRIC APPARATUS HOUSING

(71) Applicants: NEC Corporation, Tokyo (JP); NEC Platforms, Ltd., Kanagawa (JP)

(72) Inventors: Isao HIGUCHI, Tokyo (JP); Toshio NOZAWA, Kanagawa (JP)

(73) Assignees: NEC Corporation, Tokyo (JP); NEC Platforms, Ltd., Kanagawa (JP)

(21) Appl. No.: 15/509,759

(22) PCT Filed: Sep. 16, 2015
(86) PCT No.: PCT/JP2015/004706

§ 371 Date: Mar. 8, 2017

(30) Foreign Application Priority Data
Sep. 18, 2014 (JP) 2014-189909

(51) Int. Cl. H01H 21/04; H01H 21/22

(52) U.S. Cl. CPC H01H 21/04; H01H 21/22; H01H 2223/044

(57) ABSTRACT

The present invention implements, through a simple structure, the prevention of an electric shock caused by contacting an output terminal in a conducting state. This electric shock protection structure is provided with: a protective cover (40) which changes an output terminal into a non-conducting state by pressing a power switch (51) during the transition of the output terminal from a covered state to an exposed state; and a housing cover (60) which cannot be moved when the output terminal is in the non-conducting state by having an L-shaped curved section (60A), which is positioned on a different surface from the surface on which the output terminal is disposed, does not contact a contact section (44A) of the protective cover (40) when the protective cover (40) exposes the output terminal, and contacts the contact section (44A) when the protective cover (40) covers the output terminal.

### TECHNICAL FIELD

The present disclosure relates to the technical field of a structure for preventing electric shock to an operator.

### BACKGROUND ART

Power supply apparatuses such as electrical storage devices are equipped with a protective cover for preventing an electric shock which covers a power terminal in order to prevent electric shock to a person (an engineer) caused by contact with the power terminal while supplying electric power. A worker who performs power supply work such as cable connecting construction for connecting to the power terminal, for example, turns off power of the power supply apparatus and then removes the protective cover prior to starting the power supply work. If the worker forgets to turn off power in such a situation, an accidental contact with the power terminal may cause an electric shock accident. Therefore, techniques for ensuring safety to prevent electric shock accidents when a worker performs power supply work are required.

One example of such techniques is disclosed in PTL 1 which is an interlock structure that allows a cover covering an electric component to be moved to a position in which the electric component can be attached/removed only when a disconnector is placed in an off position (a non-conducting state).

PTL 2 discloses a shutter apparatus that covers a disconnection section of a switch such as a pullout breaker accommodated in a distribution panel. The apparatus is configured so that a shutter plate opens/closes in synchronization with an operation of moving the switch from a pullout position to a connecting position. The operation of inserting the switch into the apparatus opens the shutter plate and the operation of pulling out the switch from the apparatus closes the shutter plate.

PTL 3 discloses an apparatus configured to allow a battery to be quickly replaced by an easy operation without requiring a tool. The apparatus allows only one of two types of batteries to be removed/attached at a time and allows a battery that is not replaced to automatically supply power to a memory by the removing/attaching operation.

### CITATION LIST

### Patent Literature

[PTL 1] Japanese Laid-open Patent Publication No. 2013-208004

[PTL 2] Japanese Laid-open Patent Publication No. 2012-120286

[PTL 3] Japanese Laid-open Utility Model Publication No. 1993(H05)-006683

### SUMMARY OF INVENTION

### Technical Problem

It is the highest priority to ensure safety when power cable connection work or electric component replacement work or the like is performed. It is important to ensure safety to prevent an electric shock accident with a simple structure in terms of cost reduction as well.

The structure disclosed in PTL 1 controls the protective cover to be moved by an operator only when the disconnector is in the off position. The device disclosed in PTL 2 controls opening and closing of the shutter plate in synchronization with the operation of moving the switch. Accordingly, the techniques disclosed in PTL 1 and PTL 2 are inadequate to solve the problem of ensuring safety to prevent an electric shock accident with a simple structure. In PTL 3, no mention is made of a technique that solve the problem.

A primary object of the present invention is to provide an electric shock protection structure and method that solve the problem.

### Solution to Problem

An electric shock protection structure in one mode of the present invention includes: a switch capable of switching a state of an output terminal in response to a change of a posture of a movable member between a first mode and a second mode caused by an external switching operation; a cover member which is attachable to a surface where the output terminal is provided; and a housing cover, wherein the cover member is in a first state to cover the output terminal when the posture of the movable member is in the first mode while the cover member is attached to the surface, and is capable of being in a second state to expose the output terminal when the posture of the movable member is in the second mode while the cover member is attached to the surface, and the cover member includes a first contact section which, while the cover member is in a process of moving from a position in which the cover member is located in the first state to a position in which the cover member is located in the second state or in a process of being removed from the surface, contacts the movable member and then presses the movable member to change the posture of the movable member from the first mode in which the movable member conducts current to the output terminal to the second mode in which the movable member does not conduct current; and the housing cover is located on a surface different from the surface and, when the cover member is in the first state, a second contact section which is a part of the housing cover contacts a third contact section which is a part of the cover member to prevent the housing cover from moving, and when the cover member is in the second state, the second contact section does not contact the third contact section to allow the housing cover to move.

In another aspect to achieve the object described above, an electric shock protection method according to one mode of the present invention provides a cover member on a surface where an output terminal is provided and a housing cover on a surface different from the surface, wherein the cover member is in a first state to cover the output terminal when a posture of a movable member of a switch capable of switching a state of the output terminal between a first mode and a second mode in response to an external switching operation is in the first mode while the cover member is provided on the surface where the output terminal is provided, and is capable of being in a second state to expose the output terminal when the posture of the movable member is in the second mode while the cover member is provided on the surface; and, the cover member has a shape including a first contact section which, in a process of moving from a position in which the cover member is located in the first state to a position in which the cover member is in the second state or in a process of removal of the cover member from the surface, contacts the movable member and then presses the movable member to change the posture of the movable member from the first mode in which current is conducted to the output terminal to the second mode in which current is not conducted; and the housing cover includes a second contact section which, when the cover member is in the first state, contacts a third contact section which is a part of the cover member to prevent the housing cover from moving, and when the cover member is in the second state, does not contact the third contact section to allow the housing cover to move.

### Advantageous Effects of Invention

The present invention prevents electric shock due to contact with a live output terminal by using a simple structure.

### BRIEF DESCRIPTION OF DRAWINGS

FIG. 1 is a perspective view of a power supply apparatus according to a first example embodiment of the present invention (with a protective cover attached).

FIG. 2 is a perspective view of a front panel of the power supply apparatus according to the first example embodiment of the present invention (with the protective cover removed).

FIG. 3 is a cross-sectional view of the power supply apparatus according to the first example embodiment of the present invention, taken along line A-A.

FIG. 4 is a perspective view of a power supply apparatus according to a second example embodiment of the present invention (with a protective cover attached).

FIG. 5A is a perspective view of a front panel of the power supply apparatus according to the second example embodiment of the present invention (with the protective cover removed) (1 of 2).

FIG. 5B is a perspective view of the front panel of the power supply apparatus according to the second example embodiment of the present invention (with the protective cover removed) (2 of 2).

FIG. 6 is a front view of the front panel of the power supply apparatus according to the second example embodiment of the present invention (with the protective cover removed).

FIG. 7 is a perspective view of the protective cover removed from a housing cover in the second example embodiment of the present invention.

FIG. 8 is a cross-sectional view of the power supply apparatus according to the second example embodiment of the present invention, taken along line B-B.

FIG. 9 is a cross-sectional view of the power supply apparatus according to the second example embodiment of the present invention, taken along line C-C.

FIG. 10 is a cross-sectional view illustrating an electric shock protection structure according to a third example embodiment of the present invention, taken along an XY plane.

### DESCRIPTION OF EMBODIMENTS

Example embodiments of the present invention will be described below in detail with reference to the drawings. In the following descriptions, for convenience of explanation, 3-dimensional coordinate (X-Y-Z) vectors are illustrated in the drawings as appropriate. In the example embodiments described below, the X-axis and Y-axis directions are horizontal directions and the Z-axis direction is the vertical direction.

### First Example Embodiment

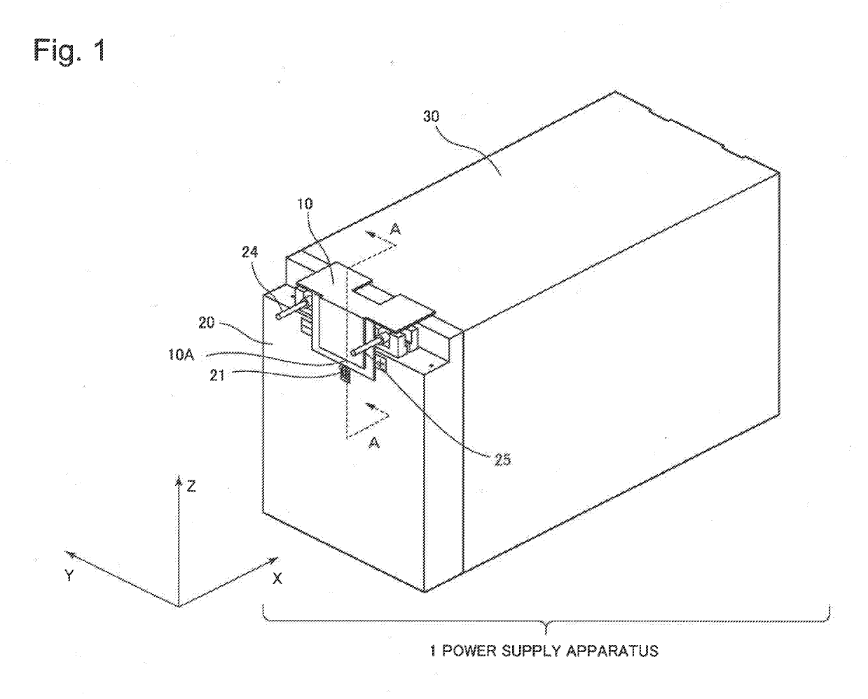

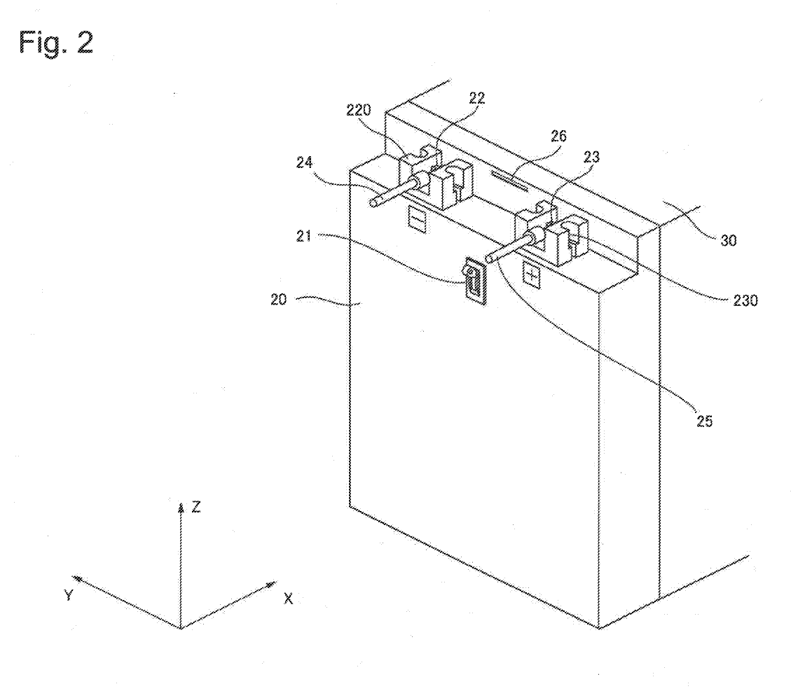

FIG. 1 is a perspective view of a power supply apparatus 1 according to a first example embodiment with a protective cover 10 attached to the power supply apparatus 1. FIG. 2 is a perspective view of the power supply apparatus 1 according to the present example embodiment with the protective cover 10 removed.

The power supply apparatus 1 supplies power to another electric apparatus through power cables 24 and 25 connected to power terminals 22 and 23. In the present example embodiment, the power terminal 22 is a negative terminal and the power terminal 23 is a positive terminal. The power terminals 22 and 23 are insulated from a front panel 20 and a housing cover 30 by terminal blocks 220 and 230 made of resin such as plastic. The terminal blocks may be made of any insulating material.

During power supply from the power supply apparatus 1, the protective cover 10 is attached to the front panel 20 and the housing cover 30 with screws (not depicted), for example, as illustrated in FIG. 1 in order to prevent electric shock. When a worker performs power cable connection work, for example, the worker needs to turn off a power switch 21 to stop power supply through the power terminals 22 and 23 before the worker can remove the protective cover 10. In the present example embodiment, the power switch 21 is in the on state when the power switch 21 is on the positive side of the Z-axis and in the off state when the power switch 21 is on the negative side.

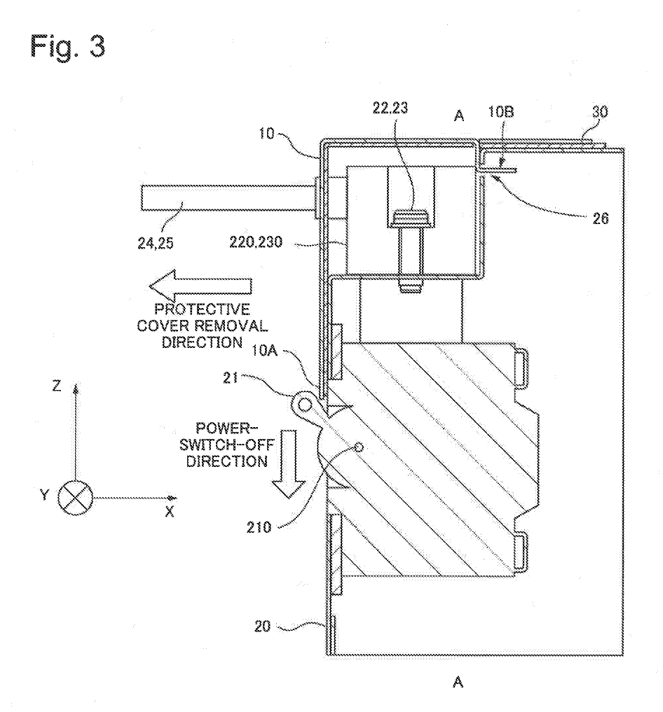

FIG. 3 illustrates a cross-sectional view of the power supply apparatus 1, taken along line A-A in FIG. 1. The cross-sectional view in FIG. 3 is a cross-sectional view parallel to an XZ plane. When the protective cover 10 is attached to the power supply apparatus 1, the protective cover 10 is fixed with screws, for example, with an L-shaped curved section 10B, which is a part of the protective cover 10, being inserted in an opening 26 provided in the front panel 20.

In the present example embodiment, the direction of removal of the protective cover 10 from the front panel 20 is parallel or substantially parallel to the negative direction of the X-axis as illustrated in FIG. 3. During removal of the protective cover 10, a contact section 10A which is a part of the protective cover 10 contacts the power switch 21 and then presses the power switch 21 in the removal direction. The power switch 21 pressed by the contact section 10A turns around a power switch rotation axis 210 and moves in parallel or substantially in parallel to the negative direction of the Z-axis. This places the power switch 21 in the off state and the power supply apparatus 1 stops power supply.

The power supply apparatus 1 according to the present example embodiment prevents electric shock due to contact with a live power terminal by using a simple structure. The reason is that when the protective cover 10 is removed from the front panel 20, the protective cover 10 contacts and then presses the power switch 21 to turn the power switch 21 from on to off.

When a worker performs power supply work during which the worker directly contacts a power feed point in a power supply apparatus, the worker may forget to turn off power, which can result in an electric shock accident. In the power supply apparatus 1 according to the present example embodiment, the protective cover 10 presses the power switch 21 in the process of removal of the protective cover 10, thereby placing the power switch 21 in the off state. Accordingly, the power supply apparatus 1 prevents occurrence of such an electric shock accident. In addition, the structure included in the power supply apparatus 1 in order to prevent such an electric shock accident is simple.

The shape and removal direction of the protective cover 10 described and depicted in the present example embodiment are merely illustrative. The protective cover 10 may have a shape different from the shape illustrated in the present example embodiment. Further, the protective cover 10 may be removed in a direction different from a direction parallel or substantially parallel to the negative direction of the X-axis as long as the power switch 21 can be placed in the off state by pressing the power switch 21 in the process of removal of the protective cover 10.

In the present invention described using example embodiments thereof as examples, the shape of the power switch is not limited to one that has a turn-style movable member (a toggle), like the power switch 21 according to the present example embodiment. The power switch 21 may have a structure that includes a movable member that moves from one position to another to turn on and off a power supply (a power line). Such a power switch may be any of various types of switches, including a slide-style switch such a DIP switch, or a seesaw switch or a button switch, for example. In this case, the protective cover contacts and then presses the movable member in the process of removal of the protective cover, thereby turning the power switch from on to off.

An apparatus that can include the electric shock protection structure of the present example embodiment is not limited to a power supply apparatus. The electric shock protection structure according to the present example embodiment is applicable to various electric apparatuses that include an electric component such as a fuse, for example, and have a structure in which an output terminal for feeding power to the electric component is exposed when the electric component is replaced.

### Second Example Embodiment

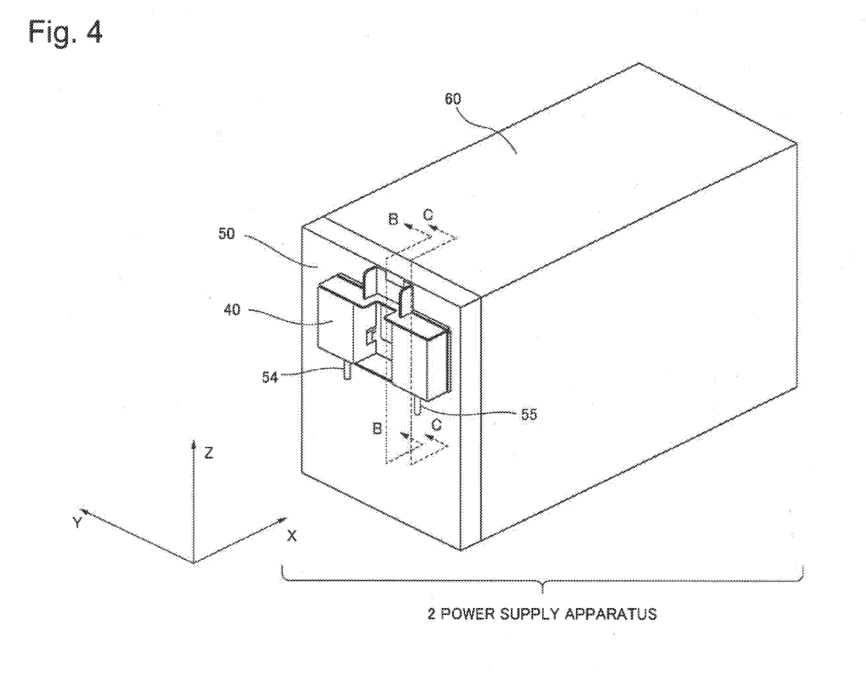

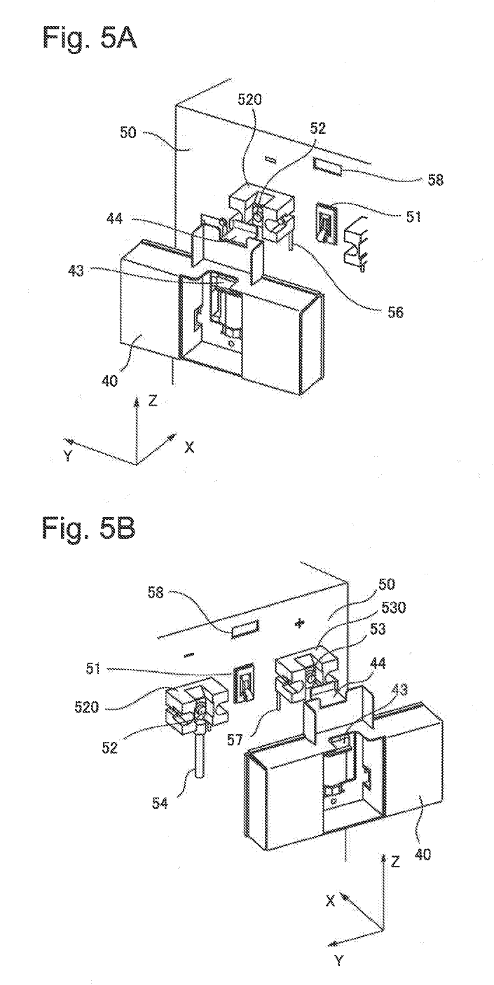

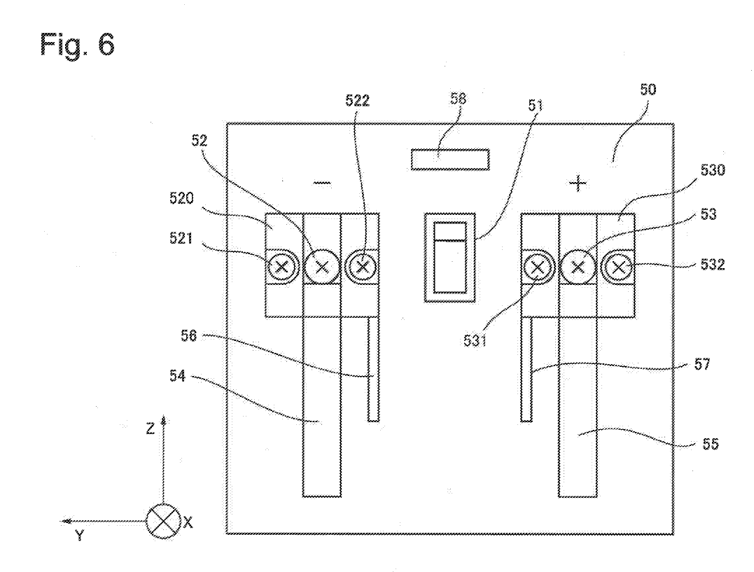

FIG. 4 is a perspective view of a power supply apparatus 2 according to a second example embodiment with a protective cover 40 attached to the power supply apparatus 2. FIGS. 5A and 5B are perspective views of a front panel 50 of the power supply apparatus 2 according to the present example embodiment with the protective cover 40 removed. FIG. 6 is a front view of the front panel 50 of the power supply apparatus 2 according to the present example embodiment with the protective cover 40 removed.

Power terminals 52 and 53 are similar to the power terminals 22 and 23 in the first example embodiment. Terminal blocks 520 and 530 are similar to the terminal blocks 220 and 230 of the first example embodiment. The terminal block 520 is fixed to the front panel 50 with screws 521 and 522 and the terminal block 530 is fixed to the front panel 50 with screws 531 and 532. Power cables 54 and 55 are similar to the power cables 24 and 25 of the first example embodiment. A power switch 51 is similar to the power switch 21 of the first example embodiment.

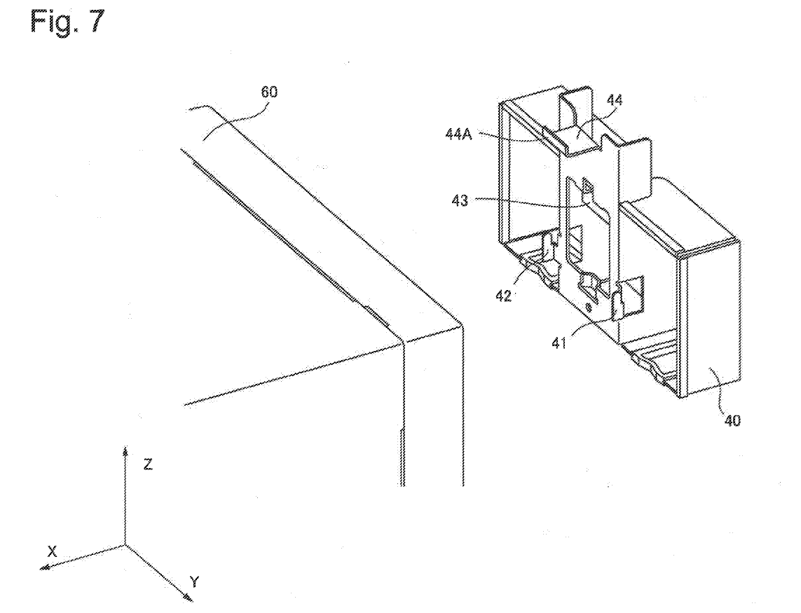

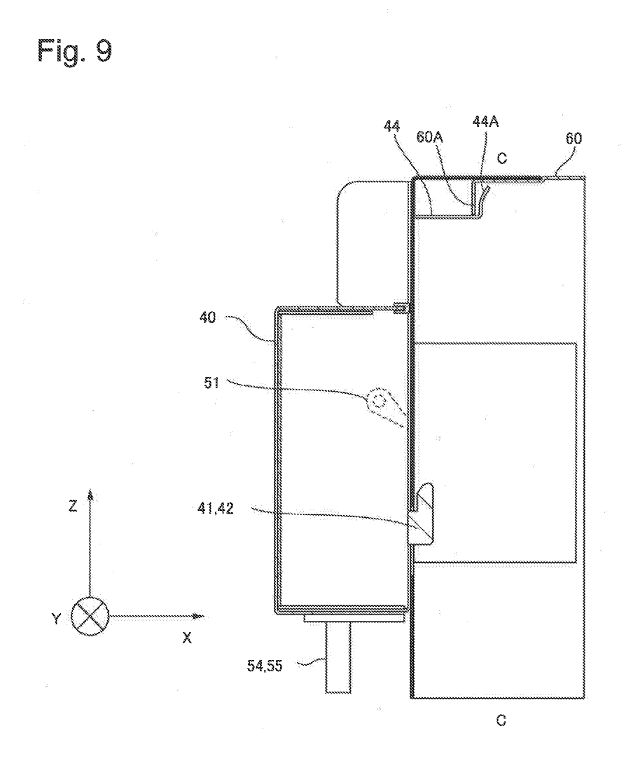

FIG. 7 illustrates a perspective view of the protective cover 40 according to the present example embodiment. As illustrated in FIG. 7, the protective cover 40 includes guide insertion sections 41 and 42, an L-shaped curved section 43 and an L-shaped curved section 44. The guide insertion sections 41 and 42 are tab-shaped and designed to be inserted into guide holes 56 and 57 depicted in FIGS. 5A, 5B and FIG. 6. The guide holes 56 and 57 are openings formed linearly (in a slit shape) in the front panel 50 in parallel or substantially in parallel to the Z-axis. FIG. 9 illustrates the guide insertion sections 41 and 42 inserted in the guide holes 56 and 57. FIG. 9 is a cross-sectional view of the power supply apparatus 2 in the present example embodiment, which is taken along line C-C in FIG. 4 and parallel to an XZ plane.

The protective cover 40 is slidable in parallel or substantially in parallel to the Z-axis on a surface of the front panel 50 without disengaging from the front panel 50 while the guide insertion sections 41 and 42 are inserted in the guide holes 56 and 57. The guide insertion sections 41 and 42 and the guide holes 56 and 57 have a mechanism that, when the guide insertion section 41 and 42 reaches the end of the guide holes 56 and 57 on the negative side of the Z-axis, allows the guide insertion sections 41 and 42 to be disengaged from the guide holes 56 and 57. This allows a worker to remove the protective cover 40 from the front panel 50.

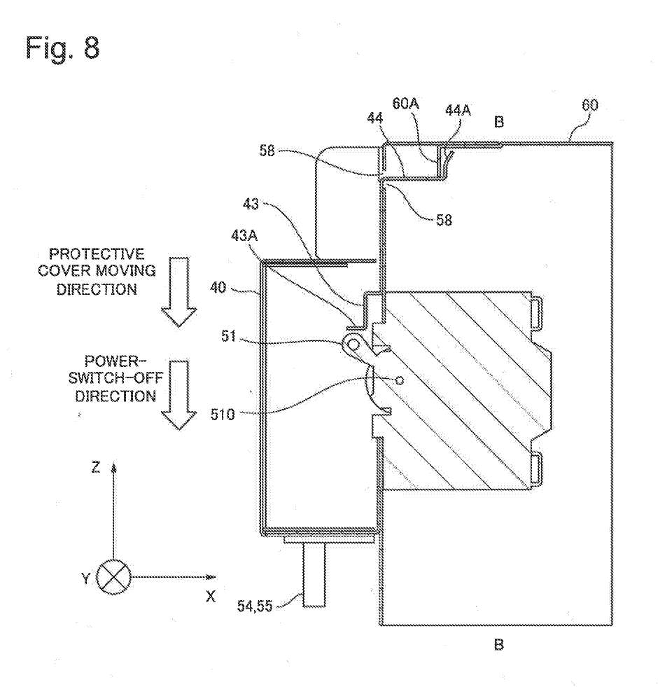

FIG. 8 illustrates a cross-sectional view of the power supply apparatus 2 taken along line B-B in FIG. 4. The cross-sectional view in FIG. 8 is a cross-sectional view in parallel to an XZ plane. When the protective cover 40 is attached to the power supply apparatus 2, the protective cover 40 is fixed with the L-shaped curved section 44 being inserted in an opening 58 formed in the front panel 50. In the present example embodiment, the opening 58 is large enough to provide a space in which the inserted L-shaped curved section 44 can move in parallel or substantially in parallel to the Z-axis as the protective cover 40 slides.

In the present example embodiment, when a worker removes the protective cover 40, the worker slides the protective cover 40 in parallel or substantially in parallel to the negative direction of the Z-axis as illustrated in FIG. 8. As the protective cover 40 moves in parallel or substantially in parallel to the negative direction of the Z-axis, a contact section 43A of the L-shaped curved section 43 contacts the switch 51 and then presses the switch 51 in the moving direction. The contact section 43A is formed perpendicularly or substantially perpendicularly to the Z axis.

The switch 51 pressed by the contact section 43A turns around a power switch rotation axis 510 and moves in parallel or substantially in parallel to the negative direction of the Z-axis. This places the power switch 51 in the off state and the power supply apparatus 2 stops power supply. The protective cover 40 can be removed from the front panel 50 after the protective cover 40 reaches the limit position beyond which the protective cover 40 is not allowed to move in parallel or substantially in parallel to the negative direction of the Z-axis.

As illustrated in FIGS. 8 and 9, a housing cover 60 includes an L-shaped curved section 60A. The L-shaped curved section 60A is formed perpendicularly or substantially perpendicularly to the X-axis and in parallel or substantially in parallel to the Z-axis. The L-shaped curved section 44 of the protective cover 40 includes a contact section 44A. Like the L-shaped curved section 60A, the contact section 44A is formed perpendicularly or substantially perpendicularly to the X-axis and in parallel or substantially in parallel to the Z-axis.

The housing cover 60 includes a structure that can be slid in parallel or substantially in parallel to the positive direction of the X-axis when a worker accesses the inside of the housing of the power supply apparatus 2. When the protective cover 40 is attached to the front panel 50 as illustrated in FIGS. 8 and 9, the contact section 44A is located in a position intersecting an axis parallel or substantially parallel to the X-axis, indicated by the direction in which the L-shaped curved section 60A moves as the housing cover 60 slides in the +X direction. Accordingly, in this case, the L-shaped curved section 60A contacts the contact section 44A to prevent the housing cover 60 from further sliding in the +X direction.

Further, assume that the worker applies a force in the −X direction in the state described above in order to remove the protective cover 40 from the front panel 50. In this case, the L-shaped curved section 60A and the contact section 44A contact (abut against) each other (FIG. 8). Then an end of the guide insertion section 41 contacts a portion above the slit-shaped opening formed by the guide hole 56 and the guide insertion section 42 contacts a portion above the slit-shaped opening formed by the guide hole 57 (FIGS. 6, 7 and 9). This means that when the worker attempts to remove the protective cover 40 from the front panel 50, the worker cannot remove the protective cover 40 because of the interference by the structure of the front panel 50 and the housing cover 60 described above.

The protective cover 40 is attached and fixed to the front panel 50 with screws or a mechanism such as a stopper (not depicted) as illustrated in FIGS. 8 and 9 when the power supply apparatus 2 is conducting current. Any common technique can be used for the structure that fixes the protective cover 40 to the front panel 50 and therefore description of the fixing structure is omitted from the description and drawings of the present example embodiment.

When the protective cover 40 is slid in parallel or substantially in parallel to the negative direction of the Z-axis in order to remove the protective cover 40 from the front panel 50, the contact section 44A also moves in parallel or substantially in parallel to the negative direction of the Z-axis. As a result, the L-shaped curved section 60A no longer contacts the contact section 44A, thereby allowing the housing cover 60 to be slid in substantially parallel to the positive direction of the X-axis. Further, this allows the protective cover 40 to be removed in the −X direction.

The power supply apparatus 2 according to the present example embodiment prevents electric shock due to contact with a live power terminal by using a simple structure. The reason is that when the protective cover 40 is removed, the protective cover 40 contacts and then presses the power switch 51 to turn the power switch 51 from on to off.

The protective cover 40 according to the present example embodiment slides on a surface of the front panel 50 along the guide holes 56 and 57 and then can be removed. In the process of the sliding of the protective cover 40, the contact section 43A contacts the power switch 51 and then presses the power switch 51 to turn the power switch 51 from on to off. In this way, the power supply apparatus 2 according to the present example embodiment turns the power switch 51 from on to off more reliably than the power supply apparatus 1 according to the first example embodiment. Accordingly, the power supply apparatus 2 according to the present example embodiment further increases the safety against electric shock than the power supply apparatus 1 according to the first example embodiment.

In addition, the contact section 43A according to the present example embodiment is formed perpendicularly or substantially perpendicularly to the Z-axis along which the protective cover 40 moves. This allows the contact section 43A according to the present example embodiment more reliably presses the power switch 51 to turn the power switch 51 from on to off. The protective cover 40 may be a molding made of a material such as plastic.

While the guide insertion sections 41 and 42 and the guide holes 56 and 57 determine the trajectory of movement of the protective cover 40 in the power supply apparatus 2 according to the present example embodiment, this is merely an example. For example, the front panel 50 may include a guide rail and the protective cover 40 may include a mechanism that moves along the guide rail.

In the power supply apparatus 2 according to the present example embodiment, the contact section 44A is located close to the L-shaped curved section 60A while the protective cover 40 covers the power terminals 52 and 53 (FIGS. 8 and 9). Therefore, when a worker attempts to slide the housing cover 60, these components contact each other to interfere the sliding. In this way, the power supply apparatus 2 according to the present example embodiment prevents the worker from sliding the housing cover 60 to access the inside of the housing of the power supply apparatus 2 and get electric shock while the power supply apparatus 2 is conducting current. Thus, the power supply apparatus 2 improves safety against electric shock with a simple structure.

The contact section 44A and the L-shaped curved section 60A according to the present example embodiment are formed in parallel or substantially in parallel to the Z-axis along which the protective cover 40 moves and perpendicularly or substantially perpendicularly to the X-axis along which the housing cover 60 moves. This allows the power supply apparatus 2 according to the present example embodiment to cause the contact section 44A and the L-shaped curved section 60A to interfere to prevent the housing cover 60 from sliding when the power supply apparatus 2 is conducting current, and allows the power supply apparatus 2 to reliably eliminate the interference when the power supply apparatus 2 is not conducting current.

### Third Example Embodiment

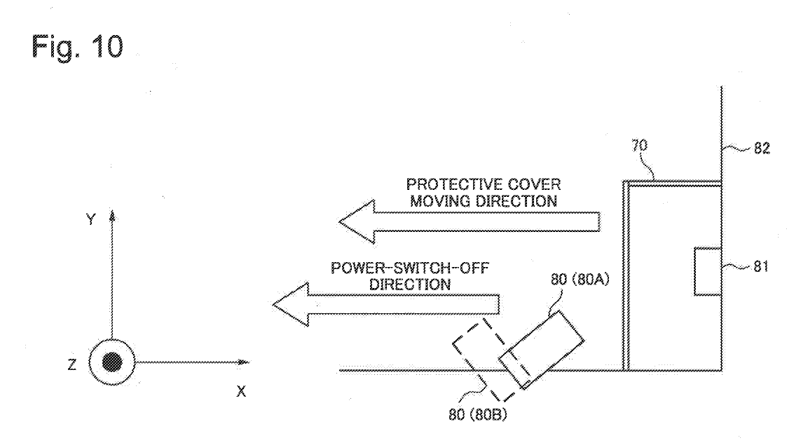

FIG. 10 is a cross-sectional view of an electric shock protection structure 3 according to a third example embodiment, taken along an XY plane.

The electric shock protection structure 3 according to the present example embodiment includes a switch 80 and a cover member 70.

The switch 80 is capable of switching a state of an output terminal 81 in response to a change of the posture of a movable member between a first mode 80A and a second mode 80B caused by an external switching operation.

The cover member 70 can be attached to a surface 82 on which the output terminal 81 is provided. When the posture of the movable member is in the first mode 80A while the cover member 70 is attached to the surface 82, the cover member 70 is in a first state to cover the output terminal 81. When the posture of the movable member is in the second mode 80B while the cover member 70 is attached to the surface 82, the cover member 70 can be in a second state to expose the output terminal 81.

The cover member 70 has a shape that, in a certain process, presses the movable member to change the posture of the movable member from the first mode 80A in which current is conducted to the output terminal 81 (the power-on state) to the second mode 80B which is non-conducting state (the power-off state). The certain process is the process of transition of the cover member 70 from the first state to the second state or the process of removal of the cover member 70 from the surface 82.

The electric shock protection structure 3 according to the present example embodiment prevents electric shock due to contact with a live output terminal by using a simple structure. The reason is that when the cover member 70 transitions to expose the output terminal 81, the cover member 70 contacts and then presses the switch 80 to turn the switch 80 from on to off.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-189909, filed on Sep. 18, 2014, the disclosure of which is incorporated herein in its entirety by reference.

### REFERENCE SIGNS LIST

1 Power supply apparatus

10 Protective cover

10A Contact section

10B L-shaped curved section

20 Front panel

21 Power switch

210 Power switch rotation axis

22 and 23 Power terminal

220 and 230 Terminal block

24 and 25 Power cable

26 Opening

30 Housing cover

2 Power supply apparatus

40 Protective cover

41 and 42 Guide insertion section

43 L-shaped curved section

43A Contact section

44 L-shaped curved section

44A Contact section

50 Front panel

51 Power switch

510 Power switch rotation axis

52 and 53 Power terminal

520 and 530 Terminal block

521 and 522 Screw

531 and 532 Screw

54 and 55 Power cable

56 and 57 Guide hole

58 Opening

60 Housing cover

60A L-shaped curved section

3 Electric shock protection structure

70 Cover member

80 Switch

80A First mode

80B Second mode

81 Output terminal

82 Surface

1. An electric shock protection structure comprising:
a switch capable of switching a state of an output terminal in response to a change of a posture of a movable member between a first mode and a second mode caused by an external switching operation;
a cover member which is attachable to a surface where the output terminal is provided; and
a housing cover,
wherein the cover member is in a first state to cover the output terminal when the posture of the movable member is in the first mode while the cover member is attached to the surface, and
the cover member is capable of being in a second state to expose the output terminal when the posture of the movable member is in the second mode while the cover member is attached to the surface;
the cover member includes a first contact section which, while the cover member is in a process of moving from a position in which the cover member is located in the first state to a position in which the cover member is located in the second state or in a process of being removed from the surface, contacts the movable member and then presses the movable member to change the posture of the movable member from the first mode in which the movable member conducts current to the output terminal to the second mode in which the movable member does not conduct current; and
the housing cover is located on a surface different from the surface and, when the cover member is in the first state, a second contact section which is a part of the housing cover contacts a third contact section which is a part of the cover member to prevent the housing cover from moving, and when the cover member is in the second state, the second contact section does not contact the third contact section to allow the housing cover to move.

2. The electric shock protection structure according to claim 1,
wherein the movable member of the switch includes a turning section which turns around a ration axis, the turning section switching between the first mode and the second mode; and
the cover member turns the turning section in response to contact with the movable member.

3. The electric shock protection structure according to claim 1,
wherein the first contact section is formed perpendicularly or substantially perpendicularly to a direction in which the cover member moves from the position in which the cover member is located in the first state to the position in which the cover member is located in the second state or a direction in which the cover member is removed from the surface.

4. The electric shock protection structure according to claim 1, further comprising a guide on the surface which restricts a trajectory along which the cover member moves from the position in which the cover member is located in the first state to a position in which the cover member is located in the second state,
wherein the cover member moves along the guide from the position in which the cover member is located in the first state to the position in which the cover member is located in the second state.

5. The electric shock protection structure according to claim 4,
wherein the guide is a linear opening formed in the surface; and
the cover member includes a section designed to be inserted in the guide.

6. The electric shock protection structure according to claim 1,
wherein the second and third contact sections are formed in parallel or substantially in parallel to a direction in which the cover member moves from the position in which the cover member is located in the first state to the position in which the cover member is located in the second state and perpendicularly or substantially perpendicularly to a direction in which the housing cover moves; and
the third contact section is located in a position intersecting a direction in which the second contact section moves as the housing cover moves, when the cover member is in the first state.

7. The electric shock protection structure according to claim 1,
wherein the cover member comprises a contact section which is located in a position facing the second contact section when the cover member is in the first state, and
capable of moving to a position not facing the second contact section when the cover member is in the second state.

8. An electric apparatus housing including the electric shock protection structure comprising:.
a switch capable of switching a state of an output terminal in response to a change of a posture of a movable member between a first mode and a second mode caused by an external switching operation;
a cover member which is attachable to a surface where the output terminal is provided; and
a housing cover,
wherein the cover member is in a first state to cover the output terminal when the posture of the movable member is in the first mode while the cover member is attached to the surface, and
the cover member is capable of being in a second state to expose the output terminal when the posture of the movable member is in the second mode while the cover member is attached to the surface;
the cover member includes a first contact section which, while the cover member is in a process of moving from a position in which the cover member is located in the first state to a position in which the cover member is located in the second state or in a process of being removed from the surface, contacts the movable member and then presses the movable member to change the posture of the movable member from the first mode in which the movable member conducts current to the output terminal to the second mode in which the movable member does not conduct current and
the housing cover is located on a surface different from the surface and, when the cover member is in the first state, a second contact section which is a part of the housing cover contacts a third contact section which is a part of the cover member to prevent the housing cover from moving, and when the cover member is in the second state, the second contact section does not contact the third contact section to allow the housing cover to move.

9. An electric shock protection method which provides:
a cover member on a surface where an output terminal is provided; and
a housing cover on a surface different from the surface;
wherein the cover member is in a first state to cover the output terminal when a posture of a movable member of a switch capable of switching a state of the output terminal between a first mode and a second mode in response to an external switching operation is in the first mode while the cover member is provided on the surface where the output terminal is provided, and
the cover member is capable of being in a second state to expose the output terminal when the posture of the movable member is in the second mode while the cover member is provided on the surface;
the cover member has a shape including a first contact section which, in a process of moving from a position in which the cover member is located in the first state to a position in which the cover member is located in the second state or in a process of removal of the cover member from the surface, contacts the movable member and then presses the movable member to change the posture of the movable member from the first mode in which current is conducted to the output terminal to the second mode in which current is not conducted; and
the housing cover comprises a second contact section which, when the cover member is in the first state, contacts a third contact section which is a part of the cover member to prevent the housing cover from moving, and when the cover member is in the second state, does not contact the third contact section to allow the housing cover to move.
